(19) United States
(12) Patent Application Publication
(10) Pub. No.: US 2010/0085861 A1
(43) Pub. Date: Apr. 8, 2010

(54) LENS SYSTEM FOR SCANNING DEVICE

(75) Inventors: Henri M.J. Boots, Eindhoven (NL); Sjoerd Cornelis Stallinga, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/515,807

(22) PCT Filed: Nov. 20, 2007
(86) PCT No.: PCT/IB2007/054704

§ 371 Date: Dec. 2, 2009

(30) Foreign Application Priority Data
Nov. 27, 2006 (EP) 06124803.5

(51) Int. Cl. G11B 7/00; G02B 13/00

(52) U.S. Cl. 369/112.23; 359/724; G9B/7

(57) ABSTRACT

A lens system includes a lens (18) and a non-periodic phase structure (16). A temperature-dependence of the spherical aberration of the lens is compensated by a temperature dependence of the spherical aberration of the non-periodic phase structure. A wavelength-dependence of the defocus of the lens is compensated by a wavelength-dependence of the defocus of the non-periodic phase structure. A wavelength-dependence of the spherical aberration of the non-periodic phase structure is compensated by a wavelength-dependence of the spherical aberration of the lens.

### FIELD OF THE INVENTION

The invention relates to a lens system for converging a radiation beam on an information layer of an optical record carrier. The invention also relates to an optical head including such a lens system and to a scanning device comprising such an optical head.

### BACKGROUND OF THE INVENTION

The increase in information density of record carriers in the field of optical according is accompanied by a commensurate decrease of the size of the radiation spot for scanning the record carrier. The decrease of the spot size is achieved by a shorter wavelength and a higher numerical aperture (NA) of the radiation beam incident on the record carrier. The Compact Disc (CD) system uses a wavelength of 780 nm and a numerical aperture of 0.45. The Digital Versatile Disc (DVD) system has a higher information density and uses a wavelength of 640 nm and a numerical aperture of 0.65. A recent development towards even higher information densities has resulted in the Blu-Ray Disc (BD) system, which operates at a wavelength of 406 nm and a numerical aperture of 0.85. The smaller wavelengths and the larger numerical apertures decrease the tolerance ranges for temperature and wavelength variations of lenses used for forming the radiation spot. Plastic lenses are preferred over glass lenses because of manufacturing cost. However, the small tolerance ranges pose a serious problem for the use of plastic lenses in optical recording systems such as the BD system.

During operation the optical head may warm up to temperatures of 50° C. The increase in temperature changes the shape of the lens due to thermal expansion and also changes the refractive index of the lens material. The resulting aberration, mainly spherical aberration, must be compensated for. The temperature induced spherical aberration increases with the size of the lens. The size of the lens is preferably not too small for reasons of manufacturability and freedom of design of the light path in the optical head.

A high-NA lens may also cause a problem during the transition between reading and writing on a record carrier. The required change in power of the radiation beam when switching from reading to writing is effected by a change in driving current of the laser used for generating the radiation beam. The change in driving current is accompanied by a change in output wavelength of the laser of about 1 nm. This change in wavelength does usually not introduce an amount of spherical aberration that needs compensation. However, it does cause a defocus effect that is relatively large. The defocus results in a displacement of the radiation spot along the optical axis. This displacement cannot be compensated by the focus servo system of the scanning device, because the response time of the servo system is much longer than the short time interval between the reading and writing states. Hence, the defocus effect caused by the wavelength change should be compensated.

### SUMMARY OF THE INVENTION

It is object of the invention to provide a lens system corrected for temperature-induced spherical aberration and wavelength-induced defocus effects.

The object is achieved in a lens system including a lens and a non-periodic phase structure, wherein a temperature-dependence of the spherical aberration of the lens is compensated by a temperature dependence of the spherical aberration of the non-periodic phase structure, a wavelength-dependence of the defocus of the lens is compensated by a wavelength-dependence of the defocus of the non-periodic phase structure, and a wavelength-dependence of the spherical aberration of the non-periodic phase structure is compensated by a wavelength-dependence of the spherical aberration of the lens.

The non-periodic phase structure (NPS) is a ring shaped structure on a surface of an optical component. It comprises a plurality of annular areas arranged at different heights, such that adjacent areas generate a predetermined optical path difference for radiation reflected off or transmitted through the phase structure. An appropriate choice of width and height of the areas and, for a trans-missive phase structure, material of the NPS will compensate the temperature-dependent spherical aberration and the wavelength-dependent defocus of the lens. The compensation of the defocus results in a free-working distance of the lens that is substantially independent of small changes in the wavelength. It should be noted that ‘defocus’ relates to the Zernike term A₂₀. A good compensation is achieved if the NPS has at least one-step height between neighboring areas having an optical height of at least 5λ, more preferably 10λ, where λ is the design vacuum wavelength. Each single aberration is preferably smaller than 30 mλ after compensation.

The production spread in the wavelength of blue lasers may cause a problem when an NPS is used for compensation of aberrations in a lens system. The production spread results in a spread of the wavelength of lasers over a range from e.g. 402 nm to 410 nm. Any defocus effects of the lens system due to these different wavelengths can be compensated by the focus servo system. The spherical aberration caused by the lens due to the different wavelengths does in general not require compensation. However, the effect of the different wavelengths on the NPS does require compensation. According to the invention, the wavelength-dependent spherical aberration of the NPS, also called spherochromatism, is compensated by designing the lens such that it introduces a compensating wavelength-dependent spherical aberration.

The lens system according to the invention has such low aberrations that it will perform within the above-mentioned narrow tolerance ranges even when the lens of the lens system is made of plastic. The invention also allows the use of lenses that have such a size that they can be manufactured relatively easily. Larger lenses also facilitate the design of the optical path, in particular because they are less critical for alignment. The lens has preferably a diameter larger than 1.5 mm. The number of annular areas around a central area is preferably lower than ten, e.g. seven. The average width of the annular areas for a lens of 1.5 mm diameter having an NPS of seven rings on one of its surfaces is 0.09 mm, which can relatively easily be made sufficiently accurately to have low light loss.

It should be noted that the US patent application no. US2004/0047040 discloses an objective lens for a scanning system having a diffractive structure on one of its surfaces. The diffractive structure compensates a change in the spherical aberration of the lens caused by a wavelength change, a deviation of the working distance caused by fluctuation of the wavelength, and a change in the spherical aberration of the lens caused by a temperature change of the lens. The lens system according to the present invention uses a non-periodic phase structure instead of a diffracting structure. Known non-periodic phase structures compensate for variation in two different parameters. The non-periodic phase structure according to the invention compensates for variation in three different parameters: temperature changes, small changes in wavelength during operation and larger wavelength changes between different radiation sources. Moreover, the lens according to the invention can have a relatively low spherochromatism. The spherochromatism of the lens is increased to compensate for the spherochromatism of the non-periodic structure. Contrary to this, the known grating structure compensates the spherochromatism of the known lens.

Preferably, the non-periodic phase structure has a step-width w complying with

$$6 \cdot {10}^{9} \leq \frac{\overline{w} d}{{λ}^{2}} \leq 25 \cdot {10}^{9} \qquad ( 1 )$$

in which w̅ the step width averaged over the non-periodic phase structure, d the diameter of the lens and λ the design wavelength for operation of the lens system. An NPS complying with the formula facilitates the design of the lens system. The NPS is also relatively easy to make and has a reduced loss of light.

In an advantageous embodiment the lens system complies with

$$1 / 3 \leq \frac{{W}_{rms} ( SC , comp )}{{W}_{rms} ( T , uncomp )} \leq 1 \qquad ( 2 )$$

in which Wᵣₘₛ(SC, comp) is the rms value of the spherical aberration of the lens with NPS due to a 4 nm wavelength shift and Wᵣₘₛ(T, uncomp) is the rms value of the spherical aberration of the lens without NPS due to a 30° C. temperature change. The compensated aberrations are optimally balanced when they comply with the formula.

Preferably the non-periodic phase structure complies with

$$\frac{\overline{w} f}{{W}_{rms}^{2}} > 6 \cdot {10}^{8} \qquad ( 3 )$$

in which w̅ is the step width averaged over the non-periodic phase structure, f the focal length in air of the lens and Wᵣₘₛ the value of the largest single aberration after compensation, such as the temperature-dependent spherical aberration or the spherochromatism. An NPS complying with formula (3) has a relatively small number of steps to compensate the aberration.

The spherical aberration is preferably compensated over a temperature range of 30° C., which range includes a design temperature of the lens system. The design temperature may be at or near the lower limit or the higher limit of the range or substantially in the centre of the range.

The defocus is preferably compensated for a wavelength shift of 1 nm. This shift is a common shift in wavelength when a semi-conductor laser switches between reading power and the higher writing power.

The spherical aberration is preferably compensated over a wavelength range of 8 nm, which range includes a design wavelength of the lens system.

In a specific embodiment of the lens system the non-periodic phase structure is arranged on a plate because of the relatively easy manufacturability. Alternatively, the non-periodic phase structure is arranged on a surface of the lens, thereby reducing the number of components in the lens system.

The lens is preferably made of plastic to reduce the manufacturing cost.

A further aspect of the invention relates to an optical head including a radiation source for generating a radiation beam, a lens system according to the invention for converging the radiation beam on the information layer, and a detection system for converting radiation from the information layer to an electrical detector signal. The lens system improves the quality of the signals provided by the detection system.

The still further aspect of the invention further relates to a device for scanning an optical record carrier having an information layer, the device comprising an optical head according to the invention and an information-processing unit for error correction. The improved quality of the signals from the detection system results in a better quality of the information signal output by the information-processing unit.

### BRIEF DESCRIPTION OF THE DRAWINGS

The objects, advantages and features of the invention will be apparent from the following more particular description of preferred embodiments of the invention, as illustrated in the accompanying drawings, in which

FIG. 1 shows a first embodiment of the scanning device according to the invention;

FIG. 2 shows a cross-section of a non-periodic phase structure;

FIG. 3 shows a second embodiment of the scanning device according to the invention; and

FIG. 4 shows a third embodiment of the scanning device according to the invention.

### DETAILED DESCRIPTION OF EMBODIMENTS

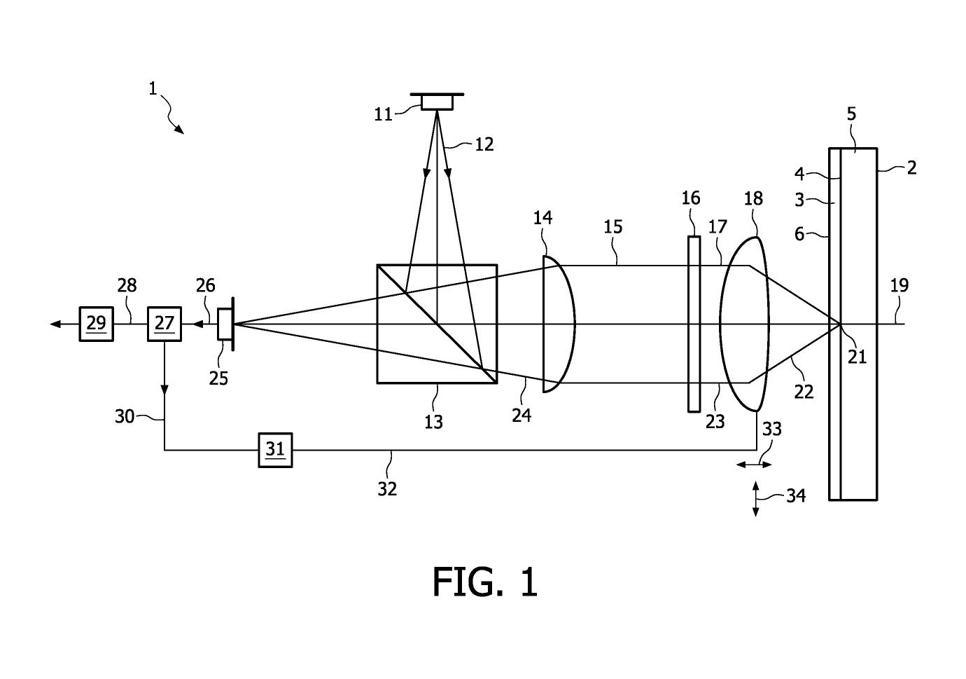

FIG. 1 shows a first embodiment of a device 1 for scanning an optical record carrier 2. The record carrier comprises a transparent layer 3, on one side of which an information layer 4 is arranged. The side of the information layer facing away from the transparent layer is protected from environmental influences by a protection layer 5. The side of the transparent layer facing the device is called the entrance face 6. The transparent layer 3 may act as a substrate for the record carrier by providing mechanical support for the information layer.

Alternatively, the transparent layer may have the sole function of protecting the information layer, while the mechanical support is provided by a layer on the other side of the information layer, for instance by the protection layer 5 or by a further information layer and a transparent layer connected to the information layer 4. The record carrier may include two or more information layers separated by one or more spacer layers. Information may be stored in the information layer 4 of the record carrier in the form of optically detectable marks arranged in substantially parallel, concentric or spiral tracks, not indicated in the Figure. The marks may be in any optically readable form, e.g. in the form of pits, or areas with a reflection coefficient or a direction of magnetization different from their surroundings, or a combination of these forms.

The scanning device 1 comprises a radiation source 11 for emitting a diverging radiation beam 12. The radiation source may be a semiconductor laser. A beam splitter 13 reflects the diverging radiation beam 12 towards a collimator lens 14, which converts the diverging beam 12 into a collimated beam 15. The collimated beam 15 is incident on a transparent compensator 16, which modifies the wave-front of the collimated beam. The radiation beam 17 coming from the compensator 16 is incident on a lens 18. The compensator 16 and the lens 18 form a lens system for converging the radiation beam onto the information layer 4. The lens system may comprise one or more lenses; it may include a grating; it may also include one or more reflective elements. The lens 18 has an optical axis 19. The lens 18 changes the beam 17 to a converging beam 20, incident on the entrance face 6 of the record carrier 2. The lens system has a spherical aberration correction adapted for passage of the radiation beam through the thickness of the transparent layer 3. The converging beam 20 forms a spot 21 on the information layer 4.

Radiation reflected by the information layer 4 forms a diverging beam 22, transformed into a substantially collimated beam 23 by the lens 18 and subsequently into a converging beam 24 by the collimator lens 14. The beam splitter 13 separates the forward and reflected beams by transmitting at least part of the converging beam 24 towards a detection system 25. The detection system captures the radiation and converts it into electrical output signals 26. A signal processor 27 converts these output signals to various other signals. One of the signals is an information signal 28, the value of which represents information read from the information layer 4. The information signal is processed by an information-processing unit 29 for error correction. Other signals from the signal processor 27 are the focus error signal and radial error signal 30. The focus error signal represents the axial difference in height between the spot 21 and the information layer 4. The radial error signal represents the distance in the plane of the information layer 4 between the spot 21 and the centre of a track in the information layer to be followed by the spot. The focus error signal and the radial error signal are fed into a servo circuit 31, which converts these signals to servo control signals 32 for controlling a focus actuator and a radial actuator respectively. The actuators are not shown in the Figure. The focus actuator controls the position of the lens 18 in the focus direction 33, thereby controlling the actual position of the spot 21 along the optical axis 19 such that it coincides substantially with the plane of the information layer 4. The radial actuator controls the position of the lens 18 in a radial direction 34, thereby controlling the radial or transverse position of the spot 21 such that it coincides substantially with the central line of track to be followed in the information layer 4. The tracks in the Figure run in a direction perpendicular to the plane of the Figure.

The device of FIG. 1 may be adapted to scan also a second type of record carrier having a thicker transparent layer than the record carrier 2. The device may use the radiation beam 12 or a radiation beam having a different wavelength for scanning the record carrier of the second type. The NA of this radiation beam may be adapted to the type of record carrier. The spherical aberration compensation of the lens system must be adapted accordingly.

According to the invention the operation of the lens is improved by arranging the compensator 16 in the path of the radiation beam. The compensator may be arranged at the side of the lens 18 facing the record carrier 2 or at the side facing the laser 11. The latter side is preferred because the compensator can be larger, facilitating its manufacture. In FIG. 1 the compensator is in the form of a plane parallel plate arranged in the incoming collimated beam 15. The plate carries a non-periodic phase structure on one of its sides.

The design of the lens system starts with optimizing the lens to form an optimum spot 21 at a design temperature, e.g. 20° C., and a design wavelength, e.g. 406 nm. In the second step of the design, the combination of the compensator and the lens is optimized for an optimum spot, under three different conditions. The first condition is operation at the design wavelength and an elevated temperature, e.g. 50° C., with adjustment of the spot position along the optical axis. The adjustment of the spot position means that the focus actuator will control the axial position of the spot such that the defocus is minimized. This is reasonable for the usually slow changes of the temperature of the lens system in the scanning device. The second condition is operation at the design temperature and a wavelength slightly different from the design wavelength, e.g. 407 nm, without adjustment of the spot position. This condition is typical for the case when the power of the laser changes from read to write power or vice versa, which change is faster than the minimum response time of the focus actuator. The third condition is operation at the design temperature and a wavelength substantially different from the design wavelength, e.g. 402 nm, with adjustment of the spot position. This wavelength change is typical for production spread of semi-conductor lasers. Since this wavelength change is static, the focus actuator will be able to minimize the defocus.

The lens 18 shown in FIG. 1 has an NA of 0.85 for operation at a wavelength of 406 nm and focusing through a transparent layer 3 of 0.1 mm thickness. The lens is made of COC, having a refractive index of 1.55030 at a wavelength of 402 nm, 1.54982 at 406 nm, 1.54969 at 407 nm and 1.54931 at 410 nm. The linear expansion coefficient of COC is equal to −60·10⁻⁶/K and the change of the refractive index as a function of temperature is equal to −10·3·10⁻⁵/K. The lens has a thickness on the optical axis of 2.05 mm, a diameter of the entrance pupil of 2.00 mm, a focal distance of 1.2 mm in air and a free working distance between the exit surface of the lens and the entrance surface 6 of the record carrier of 0.132 mm.

In the first step, the lens is designed to operate without the compensator 16 at a temperature of 20° C. and a wavelength of 406 nm. It produces a relatively low-quality spot 21 when the temperature is changed with refocusing and/or the wavelength is changed without refocusing. The rms value of the lowest-order spherical aberration is 38 mλ when the lens is at a temperature of 50° C. and a wavelength of 406 nm. When the wavelength of the radiation source suddenly changes from 406 nm to 407 nm on switching from reading power to writing power, the rms value of the defocus is 46 mλ. The spherical aberration caused by a change of wavelength from 406 to 402 nm at 20° C. is 7 mλ rms. The values for the spherical aberration relate to the lowest-order spherical aberration.

In the second step of the design process the non-periodic phase structure and the lens are optimized together. After the second step of the design, the rotationally symmetric shape of the surfaces of the lens can be described by the equation

z(r)=B₂r²+B₄r⁴+B₆r⁶+ . . . (3)

with z being the position of the surface in the direction of the optical axis in millimeters, r the distance to the optical axis in millimeters, and Bₖ the coefficient of the k^{th} power of r. The values of Bₖ for the surface of the lens facing the radiation source 11 are from k=2 to k=12: 5.8213·10⁻¹; 9.6365·10⁻⁻²; 6.6766·10⁻²; −9.0413·10⁻²; 1.7096·10⁻¹; 9.0019·10⁻². The values of Bₖ for the surface of the lens facing the record carrier 2 are from k=2 to k=12: −1.1492; 1.8812·10¹; −2.5189·10²; 2.0621·10³; −9.1920·10³; 1.7044·10⁴.

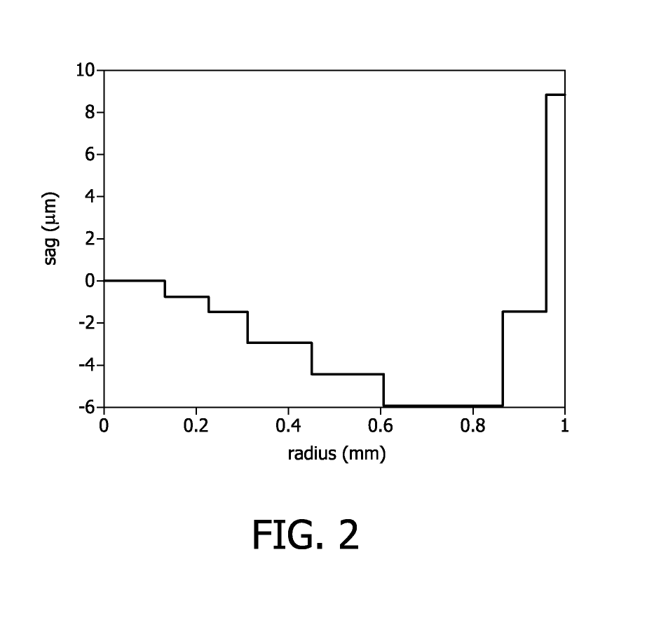

The non-periodic phase structure is made of COC. FIG. 2 shows a cross-section through the rotational-symmetric non-periodic phase structure. The horizontal axis shows the distance from the optical axis to the edge of the entrance pupil. The vertical axis shows the height of annular areas of the phase structure relative to the height of the central area. Table 1 gives the height in as a sag and width in terms of radii of each of the areas.

TABLE 1

| Radius (mm) | Sag (μm) |
|---|---|
| 0.000000-0.132712 | 0.000000000 |
| 0.132712-0.225567 | −0.738422638 |
| 0.225567-0.313364 | −1.476845276 |
| 0.313364-0.450031 | −2.953690552 |
| 0.450031-0.606510 | −4.430535828 |
| 0.606510-0.864356 | −5.911073217 |
| 0.864356-0.960855 | −1.495305842 |
| 0.960855-1.000000 | 8.838918976 |

The addition of the compensator reduces the spherical aberration of the lens system when the temperature increases from 20° C. to 50° C. from the uncompensated value of 38 mλ rms to 23 mλ rms. This is an improvement of the spot quality in terms of Strehl intensity by a factor of three, considering that the quality depends on the square of the rms value of an aberration. The defocus caused by a wavelength shift from 406 nm to 407 nm at 20° C. reduces from the uncompensated value of 46 mλ rms to 23 mλ rms. The phase structure would have introduced a spherical aberration of 31 mλ rms when the wavelength changes from 406 nm to 402 nm at 20° C. However, the special design of the lens compensates this spherical aberration to 24 mλ rms.

The value of the expression in formula (1) is equal to 15·10⁹ for the lens system. The value of the expression in formula (2) is 0.6 and in formula (3) 1.5·10⁹.

Although FIG. 1 shows the compensator 16 in the form of a non-periodic phase structure on a plate, the non-periodic phase structure may also be arranged on one of the surfaces of the lens 18. Preferably, it is arranged on the surface facing the radiation source 11. The non-periodic phase structure can be made together with the plate or the lens by plastic molding. In another method the non-period phase structure is arranged on the surface of a plate or a lens by forming a layer of UV-curable lacquer by means of a mould and hardening the lacquer by irradiating it with UV radiation.

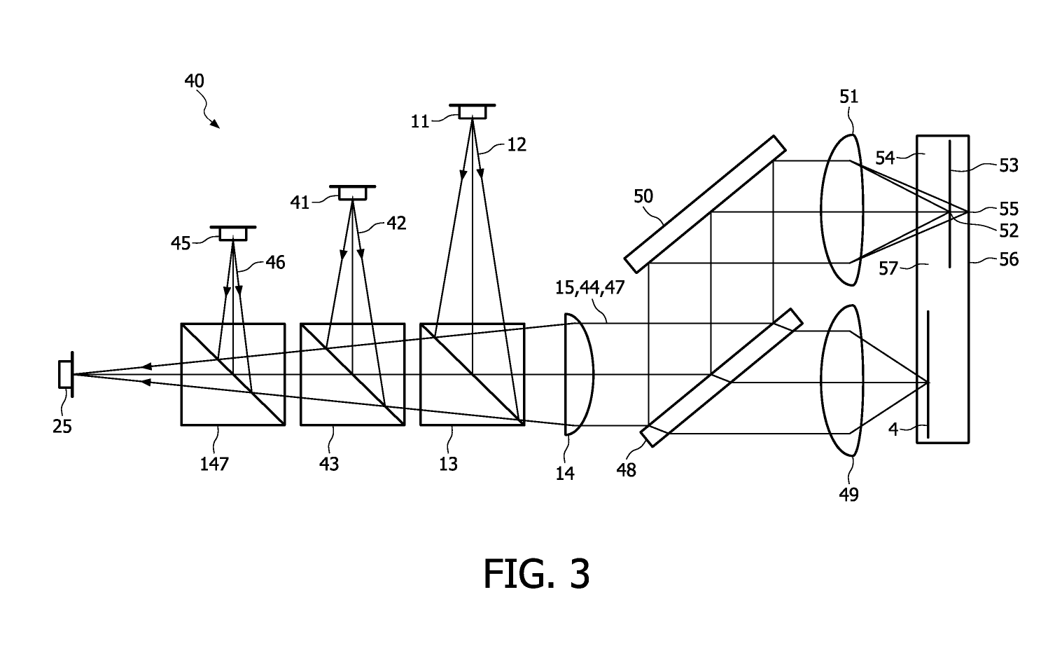

FIG. 3 shows a second embodiment of the scanning device according to the invention that can scan three different types of record carrier. The embodiment shown can read, write and/or erase on CD, DVD and BD record carriers. The scanning device includes three radiation sources. The type of record carrier to be scanned determines which radiation source is used for the scanning.

The scanning device 40 comprises the radiation source 11 for emitting the radiation beam 12 having a wavelength of 406 nm, suitable for BD type record carriers. The radiation source may be a semiconductor laser. The beam splitter 13 reflects the diverging radiation beam 12 towards the collimator lens 14, which converts the diverging beam 12 into the collimated beam 15. A radiation source 41, e.g. a semiconductor laser, emits a diverging radiation beam 42 having a wavelength of 660 nm, suitable for DVD record carriers. A beam splitter 43 reflects the radiation beam towards the collimator lens 14, which converts the diverging beam 42 into a collimated beam 44. A radiation source 45, e.g. a semiconductor laser, emits a diverging radiation beam 46 having a wavelength of 780 nm, suitable for CD record carriers. A beam splitter 147 reflects the radiation beam towards the collimator lens 14, which converts the diverging beam 46 into a collimated beam 47.

A semitransparent plate 48 transmits radiation of the BD wavelength. Hence, the collimated beam 15 will be transmitted to a lens system according to the invention comprising a lens 49. The lens has a non-periodic phase structure on its surface facing the radiation source 11. The lens converges the collimated beam 15 to the spot 21 on the information layer 4 of the BD record carrier. Radiation reflected from the information layer returns along the path of the forward radiation beam, is transmitted by the semitransparent

The semitransparent plate 48 reflects radiation of the DVD and CD wavelengths. Hence, it will reflect the collimated beams 44 and 47 towards a mirror 50 and to a lens system, shown as a single lens 51. The lens 51 converges the collimated beam 44 to a spot 52 on an information layer 53 of a DVD record carrier having a transparent layer 54 of 0.6 mm thickness. The lens 51 also converges the collimated beam 47 to a spot 55 on an information layer 56 of a CD record carrier having a transparent layer 57 of 1.2 mm thickness. A design of such a lens is disclosed in the international patent application WO2002/029798. The lens 51 may also be designed for not only CD and DVD record carriers, but also for the so-called high-density DVD (HDDVD) record carriers. Radiation reflected from the information layer returns along the path of the forward radiation beam, is reflected on the mirror 50 and the semitransparent mirror 48, transmitted by the beam splitters 13, 43 and 147 and falls on the detection system 25.

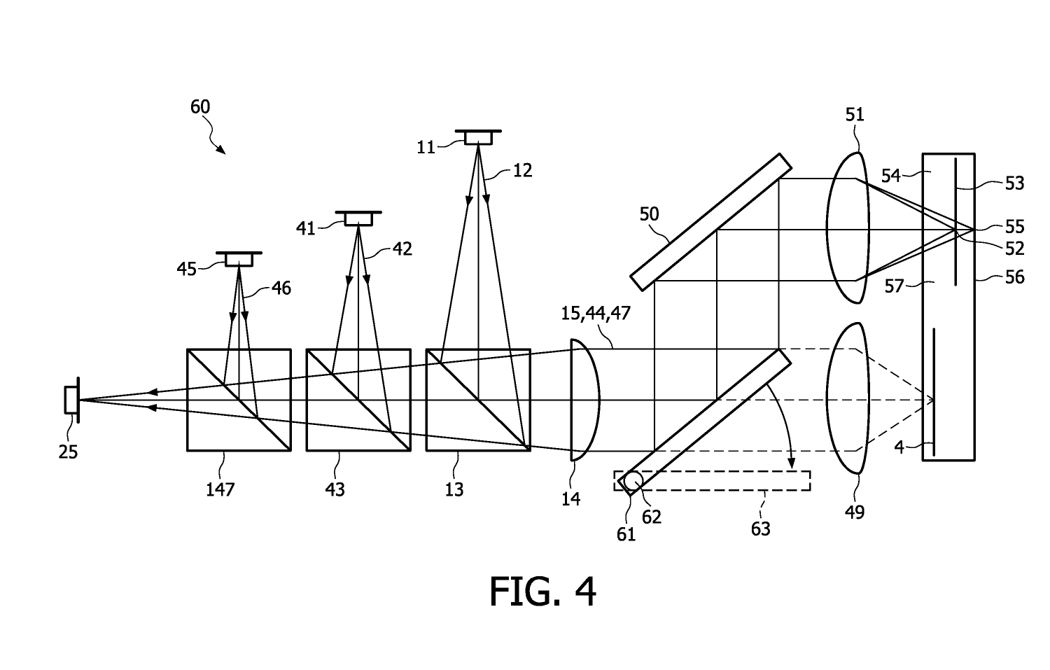

FIG. 4 shows a fourth embodiment 60 of the scanning device. The semitransparent plate 48 in the embodiment of FIG. 3 is replaced by a mirror 61 that can rotate around an axis 62. FIG. 4 shows the mirror 61 in the position for scanning record carriers of the CD and DVD type. The mirror in rotated position 63 is shown by dashed lines. In this position the scanning device can scan record carriers of the BD type.

The invention resides in each and every novel characteristic feature and each and every combination of characteristic features. Reference numerals in the claims do not limit their protective scope. Use of the verbs ‘to comprise’ and ‘to include’ and their conjugations does not exclude the presence of elements other than those stated in the claims. Use of the article ‘a’ or ‘an’ preceding an element does not exclude the presence of a plurality of such elements.

1. A lens system including a lens and a non-periodic phase structure, wherein a temperature-dependence of the spherical aberration of the lens is compensated by a temperature dependence of the spherical aberration of the non-periodic phase structure, a wavelength-dependence of the defocus of the lens is compensated by a wavelength-dependence of the defocus of the non-periodic phase structure, and a wavelength-dependence of the spherical aberration of the non-periodic structure is compensated by a wavelength-dependence of the spherical aberration of the lens.

2. The lens system according to claim 1, wherein the non-periodic phase structure has a step-width w complying with
$$6 \cdot {10}^{9} \leq \frac{\overline{w} d}{{λ}^{2}} \leq 25 \cdot {10}^{9}$$
in which w̅ is the step width averaged over the non-periodic phase structure, d the diameter of the lens and λ the design wavelength for operation of the lens system.

3. The lens system according to claim 1, complying with
$$1 / 3 \leq \frac{{W}_{rms} ( SC , comp )}{{W}_{rms} ( T , uncomp )} \leq 1$$
in which Wᵣₘₛ(SC, comp) is the rms value of the spherical aberration of the lens system due to a 5 nm wavelength shift and Wᵣₘₛ(T, uncomp) is the rms value of the spherical aberration of the lens due to a 40° C. temperature change.

4. The lens system according to claim 1, wherein the spherical aberration is compensated over a temperature range of 30° C., which range includes a design temperature of the lens system.

5. The lens system according to claim 1, wherein the defocus is compensated for a wavelength shift of 1 nm.

6. The lens system according to claim 1, wherein the spherical aberration is compensated over a wavelength range of 8 nm, which range includes a design wavelength of the lens system.

7. The lens system according to claim 1, wherein the non-periodic phase structure is arranged on a plate.

8. The lens system according to claim 1, wherein the non-periodic phase structure is arranged on a surface of the lens.

9. The lens system according to claim 1, wherein the lens is made of plastic.

10. Optical head including a radiation source for generating a radiation beam, a lens system according to claim 1, for converging the radiation beam on the information layer, and a detection system for converting radiation from the information layer to an electrical detector signal.

11. A device for scanning an optical record carrier having an information layer, the device comprising an optical head according to claim 10 and an information-processing unit for error correction.
